(19) United States
(12) Patent Application Publication
(10) Pub. No.: US 2003/0230272 A1
(43) Pub. Date: Dec. 18, 2003

(54) Valve actuation inlet noise control system

(75) Inventor: Philip Edward Arthur Stuart, Chatham (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc.

(21) Appl. No.: 10/447,531

(22) Filed: May 29, 2003

Related U.S. Application Data
(60) Provisional application No. 60/389,585, filed on Jun. 18, 2002.

(51) Int. Cl. F02M 35/10

(52) U.S. Cl. 123/184.56

(57) ABSTRACT

An engine noise control system (100) controls engine noise in multiple engine operating modes by controlling a size of an air inlet (104) with a movable valve. An actuator (114) moves the valve (112) between an open position and a closed position depending on the engine operating mode, to control the amount of air travelling into an air cleaner. The actuator (114) is coupled to an engine cylinder de-activation unit (200) to link the valve operation to the engine operating mode. When the engine is operating in a low-power mode, which requires less air, the actuator (114) moves a cable drive (204), which rotates an actuation lever (208) that turns the valve (112) into a closed position. When the engine is operating in a high-power mode, the actuator (114) moves the cable drive (204) to move the valve (112) to an open position. Reducing the effective cross sectional area of the air inlet increases a ratio between the air cleaner (102) area and the duct area, increasing the attenuation characteristics of the system.

### REFERENCE TO RELATED APPLICATIONS

The present invention claims priority to U.S. Provisional Patent Application No. 60/389,585, filed Jun. 18, 2002.

### TECHNICAL FIELD

The present invention relates to noise control systems, and more particularly to a system that controls noise in a valve actuation inlet for an engine.

### BACKGROUND OF THE INVENTION

There are currently engines designed to operate in two or more modes where different numbers of cylinders are fired during each mode. For purposes of illustration only, the example shown in the figures and described below addresses an engine having eight cylinders and that operates in two modes, one using all eight cylinders and one using only four out of the eight cylinders. However, the description below is applicable to any engine having any number of cylinders and any number of operating modes with any number of cylinders switched on and off.

During a low power mode, four out of the eight cylinders may be operated, creating an engine sound having predominantly low frequency components. In one embodiment, the signature of the engine noise is predominated by the firing frequency of the engine, which is around twice the engine rotational speed. Typically, the frequency range during this mode is around 33 to 170 Hz as the engine runs from idle to 5000 rpm.

When the engine mode is operated in a high power mode, where all eight cylinders are operating, the additional cylinders change the engine noise characteristic by increasing the frequency to, typically, four times the engine speed (e.g., around 100 to 400 Hz in the primary engine firing range).

However, currently known noise control systems are not able to adapt their noise control properties to handle the noise characteristic of different engine operating modes. This causes significant noise character changes as the engine mode switches while the noise control system does not follow suit.

There is a desire for a noise reduction system that can reliably control noise in an engine having more than one operating mode generating different noise characteristics.

### SUMMARY OF THE INVENTION

The present invention is directed to an engine noise control system that controls engine noise in multiple engine operating modes by controlling a size of an air inlet with a movable valve. An actuator moves the valve between an open position and a closed position depending on the engine operating mode.

In one embodiment, the actuator is coupled to an engine cylinder de-activation unit to link the valve operation to the engine operating mode. When the engine is operating in a low-power mode, which requires less air, the actuator moves a cable drive, which rotates an actuation lever that turns the valve into a closed position. When the engine is operating in a high-power mode, the actuator moves the cable drive to move the valve to an open position. Because the valve actuator is coupled to the engine cylinder de-activation unit, valve operation is directly linked to the engine operating mode instead of secondary characteristics (e.g., air flow characteristics).

By restricting air flow when the engine is in the low-power mode and choking off excess air that could carry engine noise, the invention attenuates low frequency noise generated by engine during the low-power mode.

### BRIEF DESCRIPTION OF THE DRAWINGS

FIG. 1 is a representative diagram of a noise control system according to one embodiment of the invention;

FIG. 2 illustrates the inventive system reducing noise during a first engine operating mode;

FIG. 3 illustrates the inventive system reducing noise during a second engine operating mode; and

FIG. 4 illustrates the system of FIG. 1 according to one embodiment of the invention in greater detail.

### DETAILED DESCRIPTION OF THE EMBODIMENTS

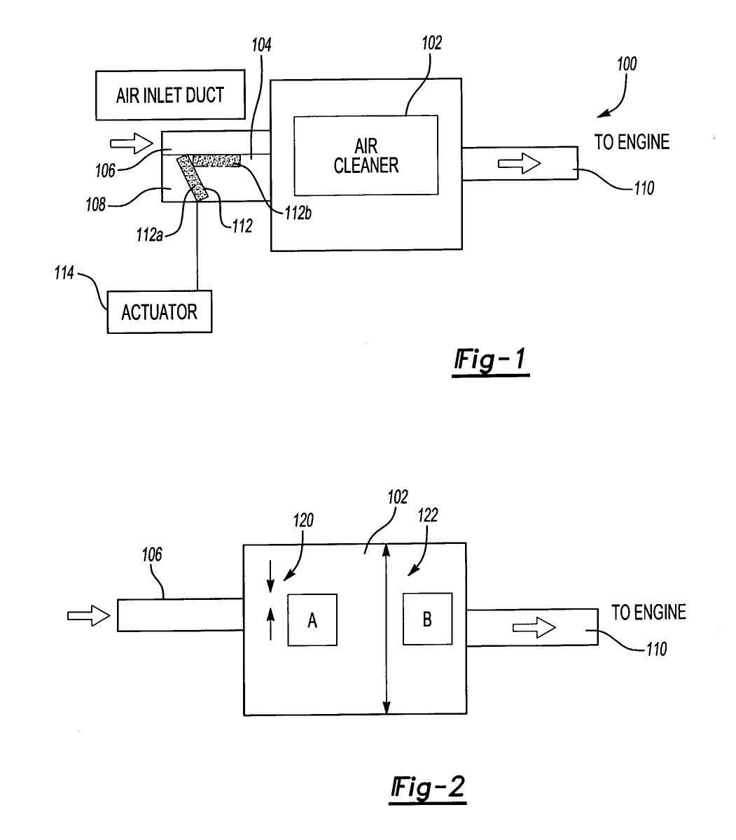

FIG. 1 is a representative diagram of a noise control system 100 according to one embodiment of the invention. In this example, the system 100 is used with an engine that can operate in a low power mode where four cylinders are operated and a high power mode where all eight cylinders are operated. The inventive noise control system 100 can be used in other modes and engine configurations without departing from the scope of the invention.

The system 100 in this embodiment is designed to cooperate with an air cleaner 102 having an air inlet 104 divided into two sections 106, 108. Note that in this embodiment, there is no physical barrier between the two sections 106, 108. An air outlet 110 connected to the air cleaner 102 allows air to flow from the air cleaner 102 to the engine (not shown).

The system 100 includes a valve 112 movably disposed in one of the sections (the second section 108 in this example). An actuator 114 connected to the valve 112 opens and closes the second section 108, causing the air inlet 104 to be made larger or smaller depending on the operating mode of the engine. In one embodiment, the actuator 114 also is coupled to a cylinder de-activation unit in the engine, causing the valve 112 operation to coincide with the change in engine mode.

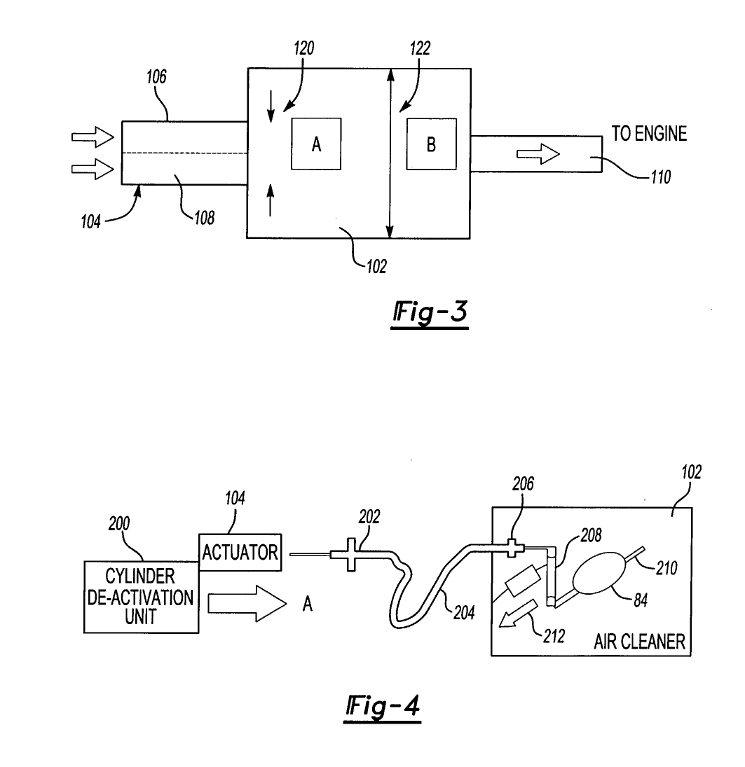

FIGS. 2 and 3 are representative diagrams of the inventive system 100 during two different operational modes. If the engine is operating at a low power mode (FIG. 2), with fewer than all of the engine cylinders firing, then the actuator 114 moves the valve 112 to a closed position 112a, effectively making the air inlet 104 smaller. Note that the actual size of the air inlet 104 stays the same, but the effective cross-sectional area of the air inlet 104 is smaller when the valve 112 is closed 112a. The smaller cross-section increases air flow restriction; however, the engine only requires approximately half of the air flow at a given engine speed in this case because it is operating in four cylinder mode instead of eight cylinder mode, thus reducing the amount of air flowing into the air cleaner 102. This reduced air inlet 104 cross-section increases the ratio between the duct area 120 and the air cleaner area 122, causing the overall noise level to drop since the expansion ratio between the duct area 120 and the air cleaner area 122 increases noise attenuation.

If the engine is running in a high power mode (e.g., with all eight cylinders), the engine will generate higher frequency noise. The actuator 114 will move the valve 112 to its open position 112b, allowing air to flow through substantially the entire cross-sectional area of the air inlet 104. Because higher frequency noise has shorter wavelengths than lower frequency noise, it is easier to attenuate. In the illustrated example, the shorter wavelength of the higher frequency noise is shorter than the length of the air cleaner 102, allowing better attenuation to be achieved. Further, the engine draws more air during the high-power mode than during the low-power mode; therefore, fully opening the valve 112 allows the maximum amount of power to be generated by the engine. By recognizing that the engine does not require as much air in the low-power mode as in the high-power mode, the valve 112 can adjust air flow to provide the maximum amount of air to the engine at each mode while maximizing noise attenuation to reduce low-frequency noise generated during the low-power mode.

FIG. 4 illustrates one embodiment of the inventive system in more detail. In this embodiment, the actuator 114 is connected to a cylinder deactivation unit 200, which controls the engine operating mode by activating and deactivating cylinders in the engine (not shown). Translation of the actuator 114 moves a first end housing 202 of a cable drive 204. The cable 204 can be any cable that can transmit either tensile or compressive loads, such as a Bowden cable or a sleeved flexible cable. In one embodiment, the first end 202 is disposed near the cylinder deactivation unit 200 and attached to the engine (not shown) or an inlet manifold (not shown). When the cylinder deactivation unit 200 deactivates selected cylinders in the engine to change the operating mode, the unit 200 also causes the actuator 114 to move in the direction of arrow A to push against the first end 202.

When the actuator 114 pushes against the first end 202, the compressive force in the cable 204 is translated to a second, movable end housing 206 attached to the other end of the cable 204. Movement of the second end 206 is translated by an actuation lever 208 to rotate a valve actuation shaft 210, which in turns rotates the valve 112. A return spring 212 has a biasing force to maintain the valve 112 in the closed position or open position, depending on the operational direction of the actuator 114. For example, if the actuator 112 operates to open the valve 112, then the return spring 212 is biased to pull the valve 112 shut. In other words, the return spring 212 is biased in a direction opposite the operational direction of the actuator 114. Because the valve actuator 114 operation is linked directly to the cylinder deactivation unit 200 operation, the inventive system integrates the mode switching with the noise control mechanism instead of responding to secondary criteria, such as air flow characteristics.

As a result, the invention provides a simple, inexpensive system that can reduce engine noise even if the engine runs at different modes. By adjusting the air flow according to the engine's air consumption needs during a given mode, the invention maximizes the air flow to the engine while maximizing noise attenuation, thus producing minimum noise at the air inlet orifice.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A noise control system for an engine having an air inlet and that operates in a first mode and a second mode, comprising:
a valve disposed in the air inlet;
an actuating mechanism operably coupled to the valve to move the valve between an open position and a closed position; and
a controller that switches the engine between the first and second mode and controls the actuating mechanism to move the valve to the open position during the first mode and to the closed position during the second mode.

2. The noise control system of claim 1, wherein the valve is disposed in the air inlet to allow air to flow through approximately half of the air inlet when the valve is in the closed position.

3. The noise control system of claim 1, wherein the actuator system comprises:
a cable having a movable end and a fixed end; and
an actuator connected to the movable end and to the controller, wherein the actuator applies a force to the cable when the controller switches to one of the first mode and the second mode.

4. The noise control system of claim 3, further comprising:
an actuation lever connected to the fixed end of the cable; and
a valve actuation shaft connected to the actuator lever and the valve, wherein movement of the actuation lever rotates the valve actuation shaft to move the valve between the open position and the closed position.

5. The noise control system of claim 4, further comprising a resilient member that applies a biasing force to the actuation lever.

6. The noise control system of claim 5, wherein the biasing force of the resilient member is in a direction opposite one direction of motion of the actuation lever when the actuation lever is actuated.

7. The noise control system of claim 3, wherein the cable is one selected from the group consisting of a Bowden cable and a sleeved flexible cable that can transmit at least one of a compressive load and a tensile load.

8. A noise control system for an engine having an air inlet and that operates in a high-power mode and a low-power mode, comprising:
a valve disposed in the air inlet, wherein the valve is disposed in the air inlet to allow air to flow through approximately half of the air inlet when the valve is in the closed position;
a cable having a movable end and a fixed end, wherein the cable transmits at least one of a tensile load and a compressive load;
a cylinder de-activation unit that switches the engine between the high-power mode and the low-power mode; and
an actuator connected to the movable end and operably coupled to the cylinder deactivation unit, wherein the actuator applies a first force to the cable when the cylinder deactivation unit switches to the high-power mode to open the valve and applies a second force to the cable when the cylinder de-activation unit switches to the low-power mode to close the valve.

9. The noise control system of claim 8, further comprising:
an actuation lever connected to the fixed end of the cable;
a valve actuation shaft connected to the actuator lever and the valve, wherein movement of the actuation lever rotates the valve actuation shaft to move the valve between the open position and the closed position.

10. The noise control system of claim 9, further comprising a resilient member that applies a biasing force to the actuation lever.

11. The noise control system of claim 10, wherein the biasing force of the resilient member is in a direction opposite one direction of motion of the actuation lever when the actuation lever is actuated.
